(19) United States
(12) Patent Application Publication
(10) Pub. No.: US 2005/0185128 A1
(43) Pub. Date: Aug. 25, 2005

(54) Liquid crystal display device with interlocking substrate sealant

(75) Inventors: Sheng-Shiou Yeh, Miao-Li (TW); Mei Ling Wu, Miao-Li (TW); Jia-Pang Pang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/026,600

(22) Filed: Dec. 30, 2004

(30) Foreign Application Priority Data
Feb. 20, 2004 (TW) 93104242

(51) Int. Cl. G02F 1/1339

(52) U.S. Cl. 349/153

(57) ABSTRACT

An IPS-LCD device (3) includes opposite first and second substrates (30, 40) in a spatial parallel relation, a liquid crystal layer (36) having liquid crystal molecules interposed between the substrates, and a peripheral sealant (37) disposed between the substrates for sealing a space therebetween. The first substrate has an over coat layer (34) covered on a surface facing the second substrate. The over coat layer defines a peripheral sealing region (341) having a plurality of holes (342). The sealant interlocks with the sealing region in the holes, which ensures that the substrates are strongly combined together. This makes the IPS-LCD device sturdy and durable.

### BACKROUND OF THE INVENTION

1. Field of the Invention

The present invention relates to liquid crystal display (LCD) devices, and more particularly to an IPS-LCD (in-plane switching LCD) device having substrates thereof strongly combined together.

2. Description of Prior Art

An LCD panel generally comprises two glass substrates, a peripheral sealant, and a multiplicity of liquid crystal molecules. The sealant is used for adhering the glass substrates together and thus forming a space therebetween. The liquid crystal molecules are filled in the space.

In a color LCD panel, a color filter layer is provided in one of the substrates, which is called a color filter substrate. A conventional method of fabricating a color filter substrate mainly includes the following steps: first, forming a black matrix made of metallic chromium (Cr) or an acrylic resin on a base substrate, the black matrix defining a plurality of holes arranged in an array; next, filling three primary color resists of R (red), G (green), and B (blue) in the holes in a regular, repeating pattern so as to form a color layer; and finally, forming an over coat layer to cover the color layer and the black matrix, the over coat layer being made of an acrylic resin or an epoxy resin or like material. The color filter substrate is thus obtained.

As shown in FIG. 4, a conventional IPS-LCD device 1 comprises a color filter substrate 10 and a TFT (thin film transistor) substrate 20 spaced apart from each other, a liquid crystal layer 16 including liquid crystal molecules (not labeled) sandwiched between the substrates 10, 20, and a plurality of spacers 18 disposed between the substrates 10, 20 for supporting the IPS-LCD device 1 and maintaining the space between the substrates 10, 20. The substrates 10, 20 are made of glass. An electrode layer 19 containing a plurality of electrodes (not labeled) is formed on the TFT substrate 20, for generating an electric field to drive the liquid crystal molecules.

The color filter substrate 10 of the IPS-LCD device 1 includes a transparent plate 11, a black matrix 12 defining a plurality of holes (not labeled), a color layer 13 filled in the holes, and an over coat layer 14 covering the black matrix 12 and the color layer 13. Further, an alignment layer 15 is formed on the over coat layer 14, facing the TFT substrate 20.

A peripheral sealant 17 interconnecting the substrates 10, 20 is directly adhered to a peripheral portion of the over coat layer 14 (instead of being directly adhered to the color filter substrate 10). With this configuration, an unused outermost peripheral portion of the transparent plate 11 and thus the color filter substrate 10 can be reduced in size, while still preserving the same area of the color filter substrate 10 that contributes to the displayed image. That is, the utilization of the areas of the substrates 10, 20 of the IPS-LCD device 1 is improved. To put it another way, the total space required for mounting of the IPS-LCD device 1 in any particular apparatus is reduced.

The sealant 17 and the over coat layer 14 are both made of a resin material or a like material. The resin material has good flatness. That is, the roughness of the sealant 17 and the over coat layer 14 is low. Accordingly, when the sealant 17 cures and combines the substrates 10, 20 together, an adhesive strength between the sealant 17 and the over coat layer 14 is poor. The sealant 17 is liable to peel off, which weakens the connection between the combined substrates 10, 20.

It is desired to provide an improved IPS type LCD device which overcomes the above-described deficiencies.

### SUMMARY OF THE INVENTION

An object of the present invention is to provide an IPS-LCD device having substrates thereof strongly combined together.

In order to achieve the object set out above, an LCD device in accordance with the present invention includes a first substrate having an over coat layer, a second substrate parallel to and spaced apart from the first substrate, a liquid crystal layer having liquid crystal molecules interposed between the substrates, and a sealant disposed between the substrates for sealing a space therebetween. The over coat layer faces the second substrate, and defines a sealing region having a plurality of holes. The sealant interlocks with the sealing region in the holes.

In assembly, the sealant is in liquid form. Part of the sealant permeates into the holes of the sealing region, and fittingly interlocks with the sealing region while curing. Thus the substrates are strongly combined together, and the IPS-LCD is sturdy and durable.

Other objects, advantages, and novel features of the present invention will become more apparent from the following detailed description when taken in conjunction with the accompanying drawings.

### BRIEF DESCRIPTION OF THE DRAWINGS

FIG. 1 is a schematic, side cross-sectional view of part of an LCD device according to the present invention.

FIG. 2 is a schematic, cross-sectional view corresponding to line II-II of FIG. 1.

FIG. 3 is an enlarged view of a circled portion III of FIG. 1.

FIG. 4 is a schematic, side cross-sectional view of part of a conventional LCD device.

### DETAILED DESCRIPTION OF THE PRESENT INVENTION

Reference will now be made to the drawings to describe the present invention in detail.

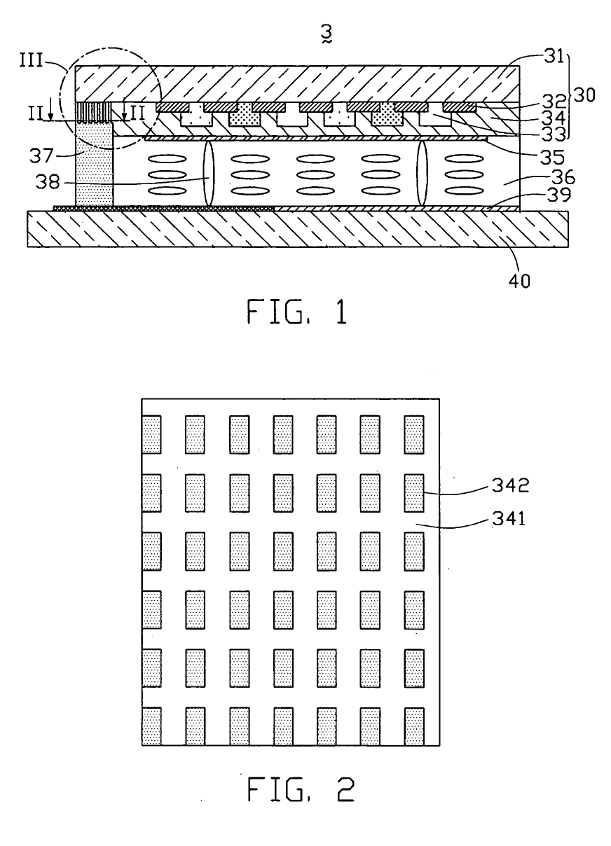

Referring to FIG. 1, an IPS-LCD device 3 of the present invention includes a color filter substrate designated as a first substrate 30, a TFT substrate designated as a second substrate 40 spaced apart from and parallel to the first substrate 30, a liquid crystal layer 36 including liquid crystal molecules (not labeled) sandwiched between the substrates 30, 40, and a sealant 37. The sealant 37 is located between respective peripheries of the substrates 30, 40, such that it combines the substrates 30, 40 together. The IPS-LCD device 3 further comprises a plurality of spacers 38 formed between the substrates 30, 40, for supporting and maintaining a space between the substrates 30, 40.

An electrode layer 39 containing a plurality of electrodes (not shown) is formed on the second substrate 40, for generating an electric field to drive the liquid crystal molecules.

The first substrate 30 of the IPS-LCD device 3 includes a transparent plate 31, a black matrix 32, a color layer 33, and an over coat layer 34 covering the black matrix 32 and the color layer 33. Further, an alignment layer 35 is formed on an underside of the over coat layer 34, facing the second substrate 40.

The black matrix 32 is made of an acrylic resin, and is arranged in a regular pattern on the transparent plate 31. The black matrix 32 defines a regular array of holes (not labeled) therein. Three primary color resists of R (red), G (green), and B (blue) are filled in the holes in a regular, repeating pattern, thereby forming the color layer 33.

The over coat layer 34 covers the black matrix 32 and the color layer 33, for eliminating the difference in height between the black matrix 32 and the color layer 33. The over coat layer 34 is made of an acrylic resin, an epoxy resin, or a like material. Also referring to FIG. 2, the over coat layer 34 includes a peripheral sealing region 341. The sealing region 341 defines a plurality of holes 342 therein arranged in a regular pattern, the holes 342 each being generally rectangular.

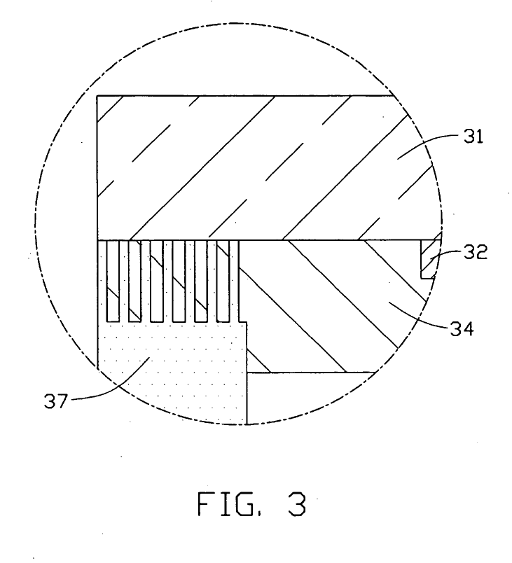

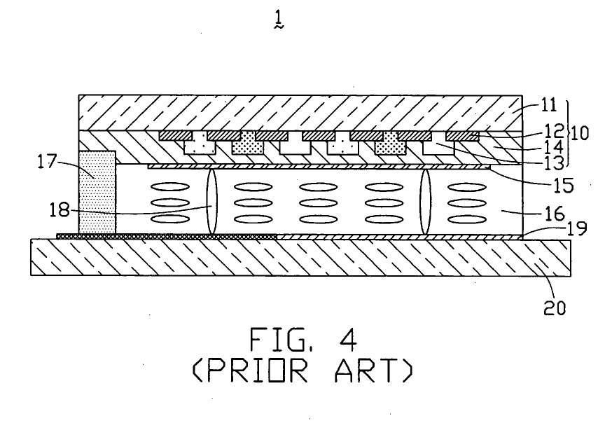

The sealant 37 adheres to the substrate 30 at the sealing region 341. During the fabricating process, in an initial step, the sealant 37 is discharged on a peripheral portion of an inner surface of the electrode layer 39. In the next step, top parts of the sealant 37 permeate into the holes 342. These parts of the sealant 37 fill the holes 342, and cross link in the sealing region 341 while curing. Referring to FIG. 3, the sealant 37 fittingly interlocks with the sealing region 341 in the holes 342. This ensures that the sealant 37 tightly adheres to the over coat layer 34, such that the substrates 30, 40 are strongly combined together. Accordingly, the IPS-LCD device 3 is sturdy and durable.

Many modifications and variations are possible within the ambit of the invention herein. For example, the holes 342 of the sealing region 341 can be cylindrical, rhombic-shaped, or have another suitable regular or irregular shape.

It is to be understood, however, that even though numerous characteristics and advantages of the present invention have been set out in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A liquid crystal display device, comprising:
a first substrate having an over coat layer;
a second substrate parallel to and spaced apart from the first substrate;
a liquid crystal layer comprising liquid crystal molecules interposed between the first and second substrates; and
a sealant disposed between the substrates for sealing a space therebetween;
wherein the over coat layer faces the second substrate, and defines a sealing region having a plurality of holes, and the sealant interlocks with the sealing region in the holes.

2. The liquid crystal display device as claimed in claim 1, wherein the holes have a regular shape.

3. The liquid crystal display device as claimed in claim 2, wherein the holes are generally rectangular.

4. The liquid crystal display device as claimed in claim 2, wherein the holes are cylindrical.

5. The liquid crystal display device as claimed in claim 2, wherein the holes are rhombic-shaped.

6. The liquid crystal display device as claimed in claim 1, wherein the holes have an irregular shape.

7. A liquid crystal display device, comprising:
a first substrate having an over coat layer;
a second substrate parallel to and spaced apart from the first substrate;
a liquid crystal layer comprising liquid crystal molecules interposed between the first and second substrates; and
a sealant disposed between the substrates for sealing a space therebetween;
wherein the over coat layer faces the second substrate, and defines a sealing region having a plurality of interlocking structures, and the sealant interlocks with the sealing region.

8. The liquid crystal display device as claimed in claim 7, wherein said sealant penetrates the coat layer.

9. A method of making a liquid crystal display device, comprising steps of:
providing a first substrate having an over coat layer;
providing a second substrate parallel to and spaced apart from the first substrate;
disposing a liquid crystal layer comprising liquid crystal molecules between the first and second substrates; and
applying a sealant disposed between the substrates for sealing a space therebetween;
wherein the over coat layer faces the second substrate, and defines a sealing region having a plurality of interlocking structures, and the sealant interlocks with the sealing region.
